(19) United States
(12) Patent Application Publication
(10) Pub. No.: US 2009/0323872 A1
(43) Pub. Date: Dec. 31, 2009

(54) Interface between a switched diversity antenna system and digital radio receiver

(75) Inventor: Nick Haller, Middletown, NJ (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignee: Sirius XM Radio Inc., New York, NY (US)

(21) Appl. No.: 12/459,425

(22) Filed: Jun. 30, 2009

Related U.S. Application Data
(60) Provisional application No. 61/133,606, filed on Jun. 30, 2008.

(51) Int. Cl. H04B 7/10; H04B 1/06

(52) U.S. Cl. 375/347; 455/277.2

(57) ABSTRACT

Methods and apparatus are presented for a digital radio receiver using antenna to receive a signal or signals using at least one other method of diversity. In exemplary embodiments of the present invention, both switched antenna diversity and at least one other method of diversity can be utilized in a digital radio broadcast system. In exemplary embodiments of the present invention the timing of an antenna control signal in a receiver can be synchronized so that switchover to a different receiving antenna can occur between adjacent blocks of data being received from whichever of the other diversity sources is then, on average, providing the better reception. For digitally coded transmissions, a clock signal can be provided by a signal processor so as to trigger a diversity controller to switch at an optimum switching time, such as, for example, between groups or “blocks” of digitally encoded information, thus eliminating or minimizing disruption of a contiguous data stream.

### CROSS REFERENCE TO RELATED APPLICATIONS

This application claims the benefit of and hereby incorporates by reference U.S. Provisional Patent Application No. 61/133,606, entitled “INTERFACE BETWEEN A SWITCHED DIVERSITY ANTENNA SYSTEM AND A DIGITAL RADIO RECEIVER” filed on Jun. 30, 2008.

### TECHNICAL FIELD

The present invention relates to satellite broadcast communications, and more particularly to systems and methods for controlling diversity switching in a receiver utilizing antenna diversity and at least one other diversity method.

### BACKGROUND INFORMATION

Radio frequency communication receivers sometimes utilize antenna diversity as a means to overcome problems associated with multipath fading in a mobile environment. For example, such receivers can be found in cellular mobile telephone systems, or for example, in systems such as those based on second generation digital cordless phones.

Conventional radio communication receivers that support antenna diversity often decide which antenna's signal should be used based upon received signal strength criteria. For example, whenever the received signal strength of the incoming signal falls below a predetermined level, the receiver can switch to a different antenna in order to thereby obtain better reception of the signal. Other conventional radio communication receivers utilize checksum errors, in addition to received signal strength, in making an antenna switch decision.

In satellite broadcast communications, such as, for example, satellite digital audio radio service (“SDARS”) systems, including the Sirius Satellite Radio, Inc. system, there can be drawbacks to the conventional method of using only received signal strength as a trigger for switching antennas at a receiver. For example, when receiving a digitally coded transmission, if antennas are switched in the middle of processing certain blocks of data, data transmission will generally be adversely affected.

What is thus needed in the art are improvements to conventional switched antenna diversity so as to overcome the aforesaid problems of the prior art, and so as to more intelligently control antenna switching decisions in a receiver.

### SUMMARY OF THE INVENTION

Methods and apparatus are presented for a digital radio receiver using antenna to receive a signal or signals using at least one other method of diversity. In exemplary embodiments of the present invention, both switched antenna diversity and at least one other method of diversity can be utilized in a digital radio broadcast system. In exemplary embodiments of the present invention the timing of an antenna control signal in a receiver can be synchronized so that switchover to a different receiving antenna can occur between adjacent blocks of data being received from whichever of the other diversity sources is then, on average, providing the better reception. For digitally coded transmissions, a clock signal can be provided by a signal processor so as to trigger a diversity controller to switch at an optimum switching time, such as, for example, between groups or “blocks” of digitally encoded information, thus eliminating or minimizing disruption of a contiguous data stream. Thus, in the likely case that one of the other diversity signals is on average stronger than the remainder, in exemplary embodiments of the present invention the diversity controller can switch receiving antennas at times synchronized to the optimum switching time of this stronger signal.

### BRIEF DESCRIPTION OF THE DRAWINGS

FIG. 1 illustrates a schematic of portions of an exemplary receiver including a switched antenna diversity controller according to an exemplary embodiment of the present invention.

### DETAILED DESCRIPTION OF THE INVENTION

While the present invention has been described with reference to certain exemplary embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

In exemplary embodiments of the present invention, a receiver utilizing antenna diversity of a signal or signals utilizing one or more other diversity techniques can synchronize the timing of an antenna control signal so as to switch receiving antennas between adjacent blocks (or other appropriate and recognizable datastream boundaries) of received data from whichever of the other diversity sources is then on average providing the better reception. Such synchronization of an antenna control signal and switchover at only appropriate points in the datastream can, for example, eliminate or minimize disruption of a contiguous data stream being received. Thus, in the likely case that one of the other diversity signals is on average stronger than the remainder, in exemplary embodiments of the present invention the diversity controller can switch receiving antennas at times synchronized to the optimum switching time of this stronger signal.

In exemplary embodiments of the present invention, a radio communication system can employ various other diversity techniques in addition to antenna diversity at a receiver. Such additional diversity techniques can include, for example, frequency diversity, time diversity, coding diversity and spatial diversity, emanating from one or more radio transmitters. Frequency diversity can include, for example, transmission and reception in which the same information signal is transmitted and received simultaneously on two or more independently fading carrier frequencies. Time diversity can be used, for example, in digital communication systems to combat problems that a transmission channel may suffer from error bursts due to time-varying channel conditions. Such error bursts, can for example, be caused by signal fading in combination with a moving receiver, transmitter or obstacle, or, for example, by intermittent electromagnetic interference, such as, for example, from crosstalk in a cable or co-channel interference from radio transmitters. In spatial diversity, multiple transmitting antennas can be spaced apart so as to combat multipath fading. Coding diversity can provide a method of multiple access that divides up a radio channel by using different pseudo-random code sequences for each user.

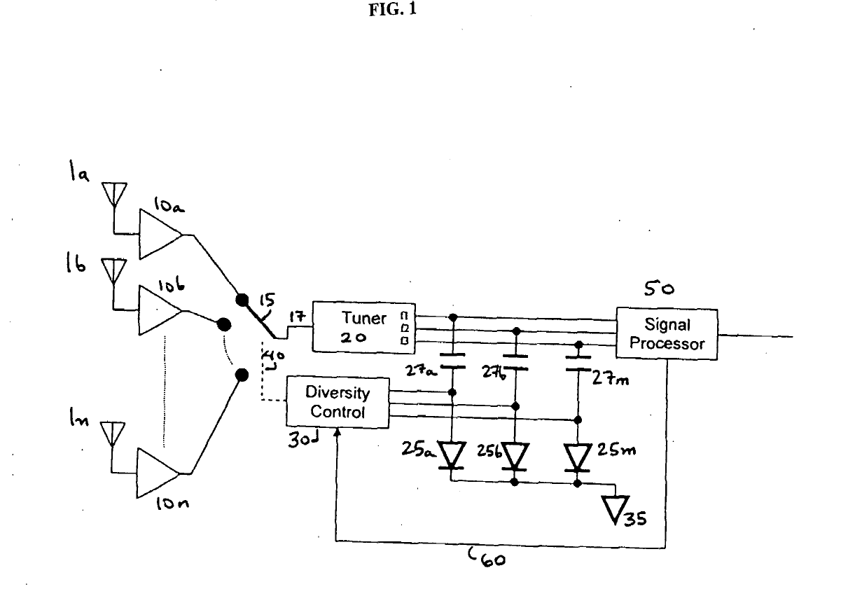

A switched diversity antenna system generally requires an indication of received power from the receiver to identify when to switch to a different receiving antenna. In exemplary embodiments of the present invention this can, for example, be provided to a diversity control circuit using a radio frequency (RF) detector at, for example, an IF output in a tuner. FIG. 1 illustrates such an exemplary control circuit in an exemplary receiver, as described below.

In exemplary embodiments of the present invention all of the various “other” (i.e., other than receiving antenna) diversity signals, such as, for example, Frequency Diversity signals, can be processed separately and combined within a signal processor. In the case of antenna diversity, however, it is necessary to provide either separate tuner circuitry and separate or multiplexed inputs to the signal processor for each antenna, or to switch between receiving antennas (or, for example, a combination of these two techniques).

In a radio communications system according to exemplary embodiments of the present invention that uses both switched antenna diversity and at least one other form of signal diversity, the various multiple signals may not necessarily all have the same optimum switching times, inasmuch as there are constantly varying signal paths from the satellite and terrestrial transmitters to the receiving antennas. For example, this is particularly true in cases where a long transmission distance is combined with high data speed, such as, for example, in satellite downlinks. Given this reality, as noted, in the likely case that one diversity signal is on average stronger than the remainder, it is advantageous for an exemplary diversity control system to switch receiving antennas at times that are synchronized to the optimum switching time of this stronger signal.

As noted, FIG. 1 depicts an exemplary diversity control system according to an exemplary embodiment of the present invention. With reference thereto, a plurality of receiving antennas 1a through 1n are shown (at the far left of the Figure). Each antenna module can, for example, be connected to a low noise amplifier (LNA), labeled 10a through 10n. Such LNAs, can, for example, be connected by coaxial cables to an RF switch 15 and in turn, a single coaxial cable 17 can, for example, be run from RF switch 15 to a tuner 20, located inside a receiver. If frequency diversity is also utilized, the frequency diversity signals can, for example, be demultiplexed in Tuner 20 and can, for example, be detected separately by RF, IF or analog circuitry. For example, in FIG. 1 this functionality can be implemented using RF Detector Diodes 25a to 25m via DC blocking capacitors 27a through 27m. The outputs of diodes 25a through 25m can be then tied to ground 35, for example. It is noted that in the example of FIG. 1 m=3, and an exemplary frequency diversity technique utilizes three separate frequencies, all shown at the output of Tuner 20 and respectively labeled f1, f2 and f3 (labels are shown at far right of Tuner 20).

In exemplary embodiments of the present invention Frequency Diversity signals f1 through f3 can be separately fed to Signal Processor 50, and can, for example, be continually (or at some regular interval, or upon the occurrence of system defined conditions) evaluated by Signal Processor 50 for signal strength, signal to noise ratio and other measures of signal quality.

In one exemplary embodiment, for example, frequency diversity, time diversity and spatial diversity (i.e., of the transmitting antennas) can all three be used together, in addition to antenna diversity (i.e., of the receivirig antennas, such as 1a through 1n). In such an embodiment, the respective indicators of signal quality can, for example, be fed from the different detectors and decoders to Diversity Control 30, along with a clock signal 60 that can be synchronized to the indicated best signal, all as shown in FIG. 1. Diversity Control 30 can, for example, use clock signal 60 to determine when to switch receiving antennas, and can use the indicators of signal quality to provide an indication of the effectiveness of the decision to switch, by, for example, using a before and after comparison.

Continuing with reference to FIG. 1, Tuner 20 can, for example, have a single demodulator (not shown), the IF output of which can be, for example, fed to three IF filters (not shown), the outputs of such three filters being Frequency Diversity signals f1, f2 and f3. In exemplary embodiments of the present invention, Tuner 20 can comprise, for example, a STA210 Tuner IC provided by ST Microelectronics, or any functionally equivalent tuner chip.

As noted, in exemplary embodiments of the present invention, Signal Processor 50, can, for example, continually determine the Signal to Noise Ratio (SNR) of each diversity signal it receives and can, for example, continually (or periodically, with some relevant frequency) determine which is the strongest. One way to determine the SNR is to include in the signal a known code sequence. Then, based on the difference between the code received and demodulated and the known, or reference, code sequence, a bit error rate can, for example, be calculated based on the number of bit errors and the length of the code. SNR is an error function of bit error rate when the noise is Gaussian. Alternatively, for example, SNR can be determined by treating an analog baseband signal as an exact signal with a remainder. In cases where the baseband signal is provided using quadrature phase shift keying (QPSK), it can be a vector. Thus, in such cases, a first noise power estimate can be taken as the average of all of the squares of all of the remainders in the x and y directions. This can be refined by considering the probability that the remainder is large enough to cause a bit error, in which case the measured remainder will also be wrong. This can, for example, result in a non linear estimated SNR against actual SNR, which is statistically predictable and can therefore be corrected by an algorithm.

Next described are further exemplary details of the exemplary switched antenna diversity system shown in FIG. 1.

In exemplary embodiments of the present invention, Signal Processor 50 can contain a clock generator (not shown) which produces clock signal 60 that can be fed to Diversity Control 30. As cluster or packet length is constant, the timing of incoming data can be determined from the post-processed data stream and this information can be added to clock signal 60. Therefore, clock signal 60, along with the timing of incoming data information, can, for example, be used by Diversity Control 30 to synchronize antenna switching so as to occur between the data blocks of the signal that has the highest SNR. Thus, signals can be switched so as to incur a minimum of informational loss, and thus eliminate or minimizing disruption of a contiguous data stream. Diversity Control can, for example, thus control antenna switching via signal 40 sent to RF switch 15.

In exemplary embodiments of the present invention, capacitors 27a, 27b and 27m can be, for example, DC blocking capacitors, which can thus allow the RF signals output from Tuner 20 to pass directly to RF Detector Diodes 25a, 25b and 25m.

In the example of FIG. 1, Diodes 25a, 25b and 25m are connected to Diversity Control 30 and to capacitors 27a, 27b and 27m, respectively. In exemplary embodiments of the present invention, assessment of the instantaneous signal strength of each of Frequency Diversity signals f1, f2 and f3 can be fed from RF detector diodes 25a, 25b and 25m directly to Diversity Control 30. Alternatively, for example, such signal strength indication can be provided by Signal Processor 50, although in such a latter exemplary implementation this indication would need to be determined by Signal Processor 50 faster than its SNR determination. Thus, if signal level were to drop suddenly, there would be no need to wait for Signal Processor 50 to assess the bit error rate before deciding to switch receiving antennas; rather, Signal Processor 50′s signal strength indication could be used to make that decision.

What is claimed:

1. A radio communications method for a signal transmitted utilizing various forms of signal diversity, comprising:
providing receiving antenna diversity;
determining received power for each receiving antenna's signal;
determining signal to noise ratio for each of the other signal diversity sources;
generating an antenna control signal that is synchronized to direct that switchover to a different receiving antenna occur at an optimum switching time, wherein said optimum switching time is a function of the characteristics of said other diversity signals.

2. The method of claim 1, wherein said optimum switching time is a time between adjacent blocks of data being received from the strongest of the other diversity signals.

3. The method of claim 2, wherein said strongest other diversity signal is the other diversity signal then on average providing the better reception.

4. The method of claim 2, wherein said strongest other diversity signal is the other diversity signal then having the highest signal to noise ratio.

5. The method of claim 1, wherein said other method of diversity is one of frequency diversity, time diversity, spatial diversity and coding diversity.

6. The method of claim 1, wherein said antenna control signal is generated by a diversity control module.

7. The method of claim 6, wherein the diversity control module takes a clock signal as an input, said clock signal being derived from the other diversity signal then having the highest signal to noise ratio, and wherein said optimum switching time is a function of said clock signal.

8. The method of claim 7, wherein said clock signal is generated by a signal processor.

9. The method of claim 1, wherein the received signals are digital, and wherein the optimum switching time is chosen to eliminate or minimize disruption of a contiguous data stream.

10. The method of claim 9, wherein the optimum switching time is between groups or blocks of digitally encoded information.

11. The method of claim 1, wherein switchover to a different receiving antenna occurs as a function of received power and said optimum switching time.

12. The method of claim 8, wherein the signal processor receives each of the other diversity signals from a tuner, continually determines the signal to noise ratio of each other diversity signal, and determines which is the strongest.

13. The method of claim 12, wherein the signal processor determines which of the other diversity signals is strongest at one of a defined regular interval, continuously and upon the occurrence of certain defined conditions.

14. The method of claim 8 wherein the signal processor assesses instantaneous signal strength of the other diversity signals.

15. The method of claim 8 wherein a set of RF detectors assesses instantaneous signal strength of the other diversity signals.

16. A digital communications receiver for receiving a signal utilizing one or more methods of transmission diversity, comprising:
at least two receiving antennas;
an RF switch;
a tuner;
a signal processor;
a plurality of RF detectors; and
a diversity controller,
wherein the receiving antenna selected by the switch is communicably connected to a tuner, the output of the tuner is communicably connected to a signal processor and a set of RF detectors, the RF detectors are communicably connected to the diversity controller, and the diversity controller is communicably connected to the RF switch and the signal processor.

17. The receiver of claim 16, wherein in operation the diversity controller generates an antenna control signal that is synchronized to direct that switchover to a different receiving antenna occur at an optimum switching time.

18. The receiver of claim 17, wherein said optimum switching time is a function of the characteristics of various transmission diversity signals received.

19. The receiver of claim 18, wherein said optimum switching time is a time between adjacent blocks of data being received from the strongest of the transmission diversity signals.

20. The receiver of claim 19, wherein said strongest transmission diversity signal is the diversity signal then on average providing the better reception.

21. The receiver of claim 19, wherein said strongest transmission diversity signal is the transmission diversity signal then having the highest signal to noise ratio.

22. The receiver of claim 19, wherein said transmission diversity is one of frequency diversity, time diversity, spatial diversity and coding diversity.

23. The receiver of claim 19, wherein said signal processor extracts a clock signal from said strongest of the transmission diversity signals and sends the clock signal to the diversity controller.

24. The receiver of claim 23, wherein the diversity controller takes the clock signal as an input, said clock signal being derived from the transmission diversity signal then having the highest signal to noise ratio, and wherein said optimum switching time is a function of said clock signal.

25. A computer program product, comprising a computer program stored on a computer readable medium, said computer program for controlling an antenna diversity system in a receiver receiving a signal utilizing one or more signal diversity methods, said computer program executable on a processor and comprising:
first program code for determining received power for each receiving antenna's signal;
second program code for determining a signal to noise ratio for each of the signal diversity sources; and
third program code for generating an antenna control signal that is synchronized to direct that switchover to a different receiving antenna occur at an optimum switching time,
wherein said optimum switching time is a function of the characteristics of said other diversity signals.

26. The computer program product of claim 25, wherein said optimum switching time is a time between adjacent blocks of data being received from the strongest of the diversity signals.

27. The computer program product of claim 26, wherein said strongest diversity signal is the diversity signal then on average providing the better reception.

28. The computer program product of claim 27, wherein said strongest diversity signal is the diversity signal then having the highest signal to noise ratio.

29. The computer program product of claim 25, wherein said one or more signal diversity methods is one of frequency diversity, time diversity, spatial diversity and coding diversity.
